(19) United States
(12) Patent Application Publication
(10) Pub. No.: US 2002/0164439 A1
(43) Pub. Date: Nov. 7, 2002

(54) Assembled charcoal funnel

(76) Inventor: Shih Yi Huang, Chang-Hua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/848,219

(22) Filed: May 4, 2001

(51) Int. Cl. B32B 1/08

(52) U.S. Cl. 428/34.1

(57) ABSTRACT

An assembled charcoal funnel having a charcoal funnel comprises a hollow body. The exterior of the body is installed with a holding portion. The body is formed by plurality of shrouds. Two lateral sides of each shroud are bent to be formed with a first embedding groove and a second embedding groove. The first embedding groove is engagable with the second embedding groove. Thus a plurality of shroud are assembled to be as a body.

### FIELD OF THE INVENTION

The present invention relates to an assembled charcoal funnel, and especially to a charcoal funnel which can be assembled and detached easily and conveniently.

### BACKGROUND OF THE INVENTION

Referring to FIG. 6, a perspective view of a prior art charcoal funnel 5 is illustrated. The charcoal funnel mainly includes a round mask 51. A grid 54 for placing charcoals 55 is installed in the mask 51. Exterior of the mask 51 is installed with a handle 52 for moving the charcoal funnel 5. Since this device has a finite volume and can not be detached, it is difficult to be carried out and the washing work is inconvenient. Since the grid can not be moved, the area of the grid 54 near the inner wall of the mask 51 is hard to be washed. Therefore, above structure is necessary to be improved.

Furthermore, with reference to FIG. 7, holes 53 at the lateral walls of the mask 51 below the grid of a prior charcoal funnel are used to vent air, and no holes exists at the lateral walls at the upper side of the grid 54 for helping the combustion of charcoals. Therefore, if the mask 51 is not made integrally, it is very possible that the connections of the components crack so as to be formed with holes, thereby inducing bad effect to the combustion of the charcoals. There, this design is not suitable to be used in an assembled charcoal funnel.

### SUMMARY OF THE INVENTION

Accordingly, the primary object of the present invention is to provide an assembled charcoal funnel having a charcoal funnel comprising a hollow body. The exterior of the body is installed with a holding portion. The body is formed by plurality of shrouds. Two lateral sides of each shroud are bent to be formed with a first embedding groove and a second embedding groove. The first embedding groove is engagable with the second embedding groove; and thus a plurality of shroud being formed with the body. The assembly of the shrouds is easy without needing any extra element.

Another object of the present invention is to provide an assembled charcoal funnel, wherein after detached, the volume thereof is reduced greatly so as to be carried easily. Furthermore, the charcoal funnel can be washed conveniently.

A further object of the present invention is to provide an assembled charcoal funnel, wherein the burning of charcoal is successful without any bad effect.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded perspective view of the present invention.

FIG. 3 is a cross sectional view of the present invention.

FIG. 4 shows the engagement of each shroud in the present invention.

FIG. 5 is a schematic view showing burning of charcoals in the charcoal funnel of the present invention.

FIG. 6 is a perspective view of a prior charcoal funnel.

FIG. 7 is a schematic view showing charcoals being burnt in a prior charcoal funnel.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

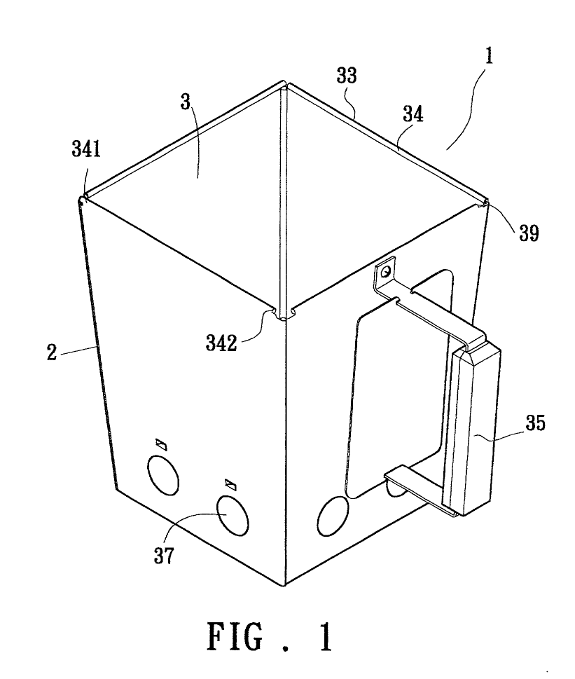

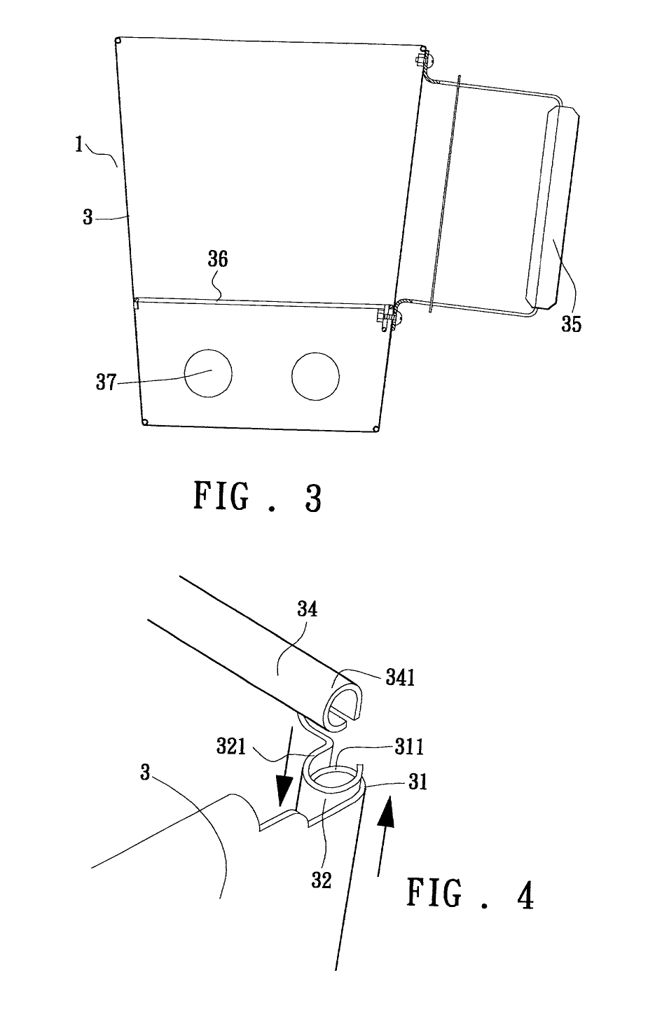

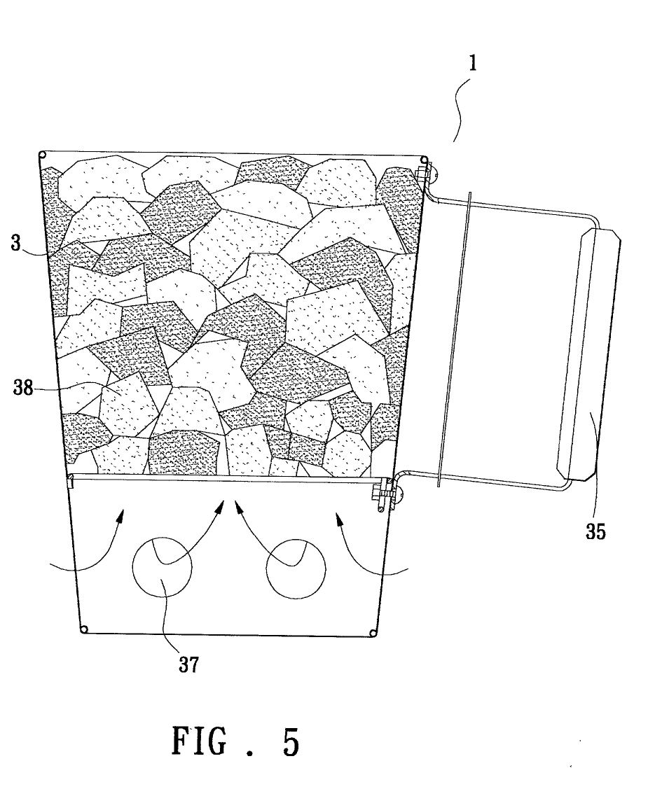

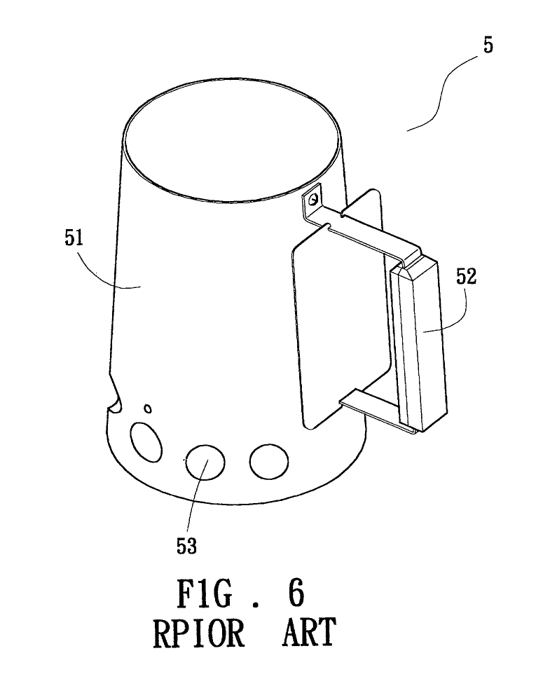

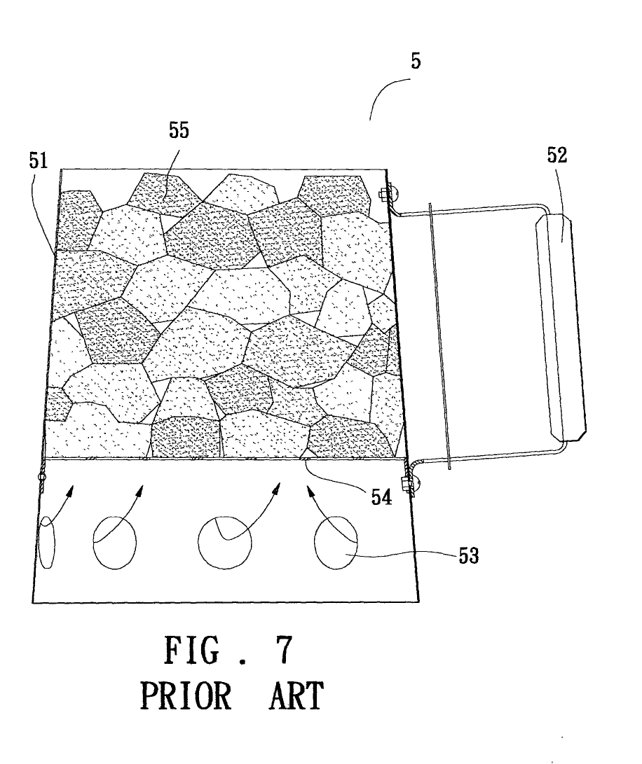

Referring to FIGS. 1 to 6, the assembled charcoal funnel 1 of the present invention is illustrated. The assembled charcoal funnel has a plurality of shrouds 3. Two sides of the each shroud 3 are bent with a first embedding groove 31 and a second embedding groove 32 which are extended along the lateral sides of these shrouds. The first embedding groove 31 and second embedding groove 32 have first opening 313 and second opening 323 longitudinally penetrated therethrough. The first opening 313 and second opening 323 are formed at the inner and outer lateral surfaces of the shroud 3. In mounting, the first embedding groove 31 of one shroud is engaged with the second embedding groove 32 of another shroud so as to be formed with a charcoal funnel body 2.

The preferred embodiment of the present invention is illustrated in FIGS. 1 to 5. In this embodiment, the charcoal funnel 1 includes a hollow body 2. A grid 36 is installed in the body 2. The exterior of the body 2 is installed with a holding portion 35. The body 2 is formed by four shrouds 3. Each shroud 3 is formed with vent 37 near the bottom thereof. Two lateral sides of each shroud 3 are bent to be formed with a first embedding groove 31 and a second embedding groove 32. Each first embedding groove 31 has a first top 311, a first bottom 312, and a first opening 313 longitudinally penetrating through the first embedding groove 31. Each second embedding groove 32 includes a second top 321, a second bottom 322, and a second opening 323 longitudinally penetrating through the second embedding groove 32. Each first opening 313 and second opening 323 are formed at the inner and outer sides of each shroud 3. The top 33 of each shroud 3 is bent with a lip 34 extending along the upper edge of the shroud. This lip 34 has a protrusion 341 and an inward reduced short end 342. Each protrusion 341 extends to be above the second top 321 of the second embedding groove 32. Each short end 342 is reduced to be formed as a space 39 with the first embedding groove 31.

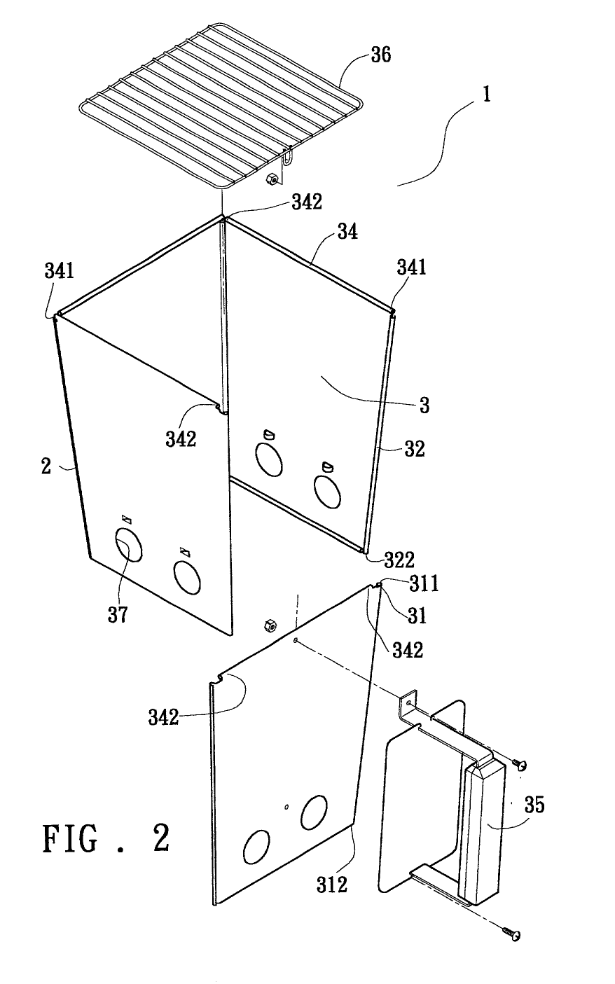

In installation (referring to FIGS. 2 and 4), the second top 311 of the first embedding groove 31 of one shroud is aligned to the second bottom 322 of the second embedding groove 32 of another shroud so that the first embedding groove 31 displaces with respect to the second embedding groove 32 until the first top 311 of the first embedding groove 31 is stopped by the protrusion 341 of the lip 34 of another shroud. It should be noted that since the final installed shroud must be engaged with two adjacent shrouds, while now by the stopping effect of the protrusion 341 of the lip 34 of the shroud, the shroud can not be engaged. Therefore, two ends of the lip 34 of one shroud must be short ends 342. Then, the grid 36 is installed at the body 2 formed by each shroud 3 and the holding portion 35 is installed at the shroud 3 with a lip 34 having two short ends 342.

After installation, charcoals 38 are placed upon the grid 36 for burning. Since the shroud 3 at the lower side of the grid 36 has holes 37 for venting air, and the body 2 is formed by engaging the first embedding groove 31 and the second embedding groove 32, it will prevent slits to be formed at engaging portion of the each shroud 3. The convention of the hot air from burning the charcoals and upper cool air dose not be effected so as to be helpful to burn the charcoals 38. The preheat of the charcoals can be performed at other place (such as funnel in the living room).

When the user holds the holding portion 35 and takes the charcoal funnel 1 upwards, the first top 311 of the first embedding groove 31 of each shroud 3 will eject the protrusion 341 of the lip 34 of an adjacent shroud so that the whole charcoal funnel 1 is lifted.

It is appreciated that the protrusion 341 of the lip 34 of each shroud 3 is selectable to be placed above the first embedding groove 31 of the shroud. This is only the change of the installing method, and thus the detail will not be further described.

It is appreciated that the shroud 3 of the present invention can be assembled without any extra elements and can be assembled and detached conveniently. After detached, the volume thereof is reduced greatly so as to be carried easily. Furthermore, the charcoal funnel 1 can be washed conveniently.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An assembled charcoal funnel having a charcoal funnel comprising a hollow body; an exterior of said body being installed with a holding portion; said body being formed by plurality of shrouds; two lateral sides of each said shroud being bent to be formed with a first embedding groove and a second embedding groove which extend along lateral sides of said shroud; each said first embedding groove having a first opening longitudinally penetrating through said first embedding groove; each said second embedding groove having a second opening longitudinally penetrating through said second embedding groove; each first opening and each second opening being formed at an inner and an outer side of each said shroud; said first embedding groove being engagable with said second embedding groove; and thus a body being formed by a plurality of shrouds.

2. The assembled charcoal funnel as claimed in claim 1, wherein the shroud has a top; said first embedding groove and said second embedding groove have respective tops, each top is bent as a lip extending along an upper edge of the shroud; said lip has a protrusion and an inward reduced short end; when said first embedding groove of one shroud is engaged to said second embedding groove of another shroud; said protrusion has a function of stopping one top of one embedding groove so that said shrouds are formed as said body.

3. The assembled charcoal funnel as claimed in claim 1 or 2, wherein both two ends of said lip of one shroud are inward reduced short ends, and said holding portion is installed at said shroud.
